(19) United States
(12) Patent Application Publication
(10) Pub. No.: US 2010/0216516 A1
(43) Pub. Date: Aug. 26, 2010

(54) TERMINAL HAVING DISPLAY SECTION

(76) Inventor: Mikio Fujiwara, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/681,670

(22) PCT Filed: Sep. 22, 2008
(86) PCT No.: PCT/JP2008/002614

§ 371 Date: Apr. 5, 2010

(30) Foreign Application Priority Data
Oct. 5, 2007 (JP) 2007-261732

(51) Int. Cl. H04W 88/02

(52) U.S. Cl. 455/566

(57) ABSTRACT

A terminal (100) is provided with a first case having an operation section (102) including a plurality of operation keys (102a-102c); a second case, which is provided with a display (106) and is turnably arranged to the first case; an angle detector (202) for detecting a turning angle of the second case to the first case; and a controller (207) for changing allocation of functions to each of the operation keys (102a-102c) of the operation section (102), corresponding to the turning angle detected by the angle detector (202).

### TECHNICAL FIELD

The present invention relates to a terminal having an operation section and s display section, more particularly to a terminal capable of changing the direction of the display section with respect to the operation section.

### BACKGROUND ART

Conventionally, there is a video display terminal having a display section of which direction can be changed with respect to a main body of the video display terminal (see, for example, patent document 1). FIG. 7 shows an appearance of such a conventional video display terminal. The video display terminal shown in FIG. 7 is a portable telephone terminal including a display section 301 having a liquid crystal display device (LCD) 303 which is turnably disposed on a top of a main body 302 of the portable telephone terminal. The display section 301 is turnably attached to the main body 302 with a hinge mechanism. The main body 302 is provided with an operation section 304 containing numeric keys and other operation keys at the lower part of the display section 301. In a state shown in FIG. 7, a direction of the longer side of the display device 303 corresponds to a length direction, and the display device 303 is usable as a vertically long screen. By turning the display section 301 with respect to the main body 302, the display device 303 can be changed in other directions (see broken lines A and B in FIG. 7).

Patent document 1: JP 2005-234137 A

### DISCLOSURE OF INVENTION

In such a conventional video display terminal, the direction of the display section can be changed freely, but the direction of the operation section cannot be changed, that is, the location of operation keys, and indications of name of keys and functions are fixed. That is, the direction of the operation section is determined so that an operator can easily operate while the display section 301 is not turned to the main body 302. Therefore, when the operator turns the display section 301, turns the main body according to the direction of the display section 301, and then holds the video display terminal in this state, the direction of the operation section 304 does not coincide with the direction of the operator. Hence, it is hard for the operator to manipulate the operation section 304. That is, since the operation section 304 is fixed on the main body 302, if the operator attempts to operate the video display terminal from a different direction than usual, it is very hard to operate.

The present invention is devised in the light of the above problems, and has an object to present a terminal which has a display section and is easy to be operated by the operator, even if the operator operates the terminal from a different direction than usual.

### MEANS FOR SOLVING THE PROBLEM

A terminal according to the invention includes a first case provided with operation section including a plurality of operation keys, a second case including a display section and provided turnably on the first case, an angle detector for detecting a turning angle of the second case with respect to the first case; and a controller for changing assignment of function of the operation key of the operation section depending on the turning angle detected by the angle detector.

### EFFECT OF THE INVENTION

According to the invention, when the operator changes the direction of the second case having the display section, the assignment of function of operation key is changed depending on the direction of the display section. As a result, the direction of the display and the direction of the operation keys are always matched, resulting in easy key manipulation by the operator.

### BRIEF DESCRIPTION OF DRAWINGS

FIGS. 1A and 1B are outline views of a video display terminal in preferred embodiment 1 of the invention.

FIG. 2 is a block diagram of configuration of the video display terminal in preferred embodiment 1 of the invention.

FIG. 3 is an outline view of a video display terminal in preferred embodiment 2 of the invention.

FIG. 4 is a block diagram of configuration of the video display terminal in preferred embodiment 2 of the invention.

FIGS. 5A and 5B are outline views of the video display terminal arranged upside down.

FIGS. 6A and 6B are diagrams showing an example of operation key arrangement disposed in point symmetry.

FIG. 7 is an outline view of a conventional video display terminal.

### DESCRIPTION OF REFERENCE NUMERALS

101 First case
102 Operation section
102a, 102b, 102c, 102d Cursor keys (up, down, right, left keys)
103 Display invert key
104 Slot
105 Second case
106 Display
107 Hinge section
202 Display turning sensor
204 Medium controller
205 Signal processor
207 Controller

### BEST MODE FOR CARRYING OUT THE INVENTION

Best modes for carrying out the invention are described below while referring to the accompanying drawings.

### Embodiment 1

### 1. Outline of Video Display Terminal

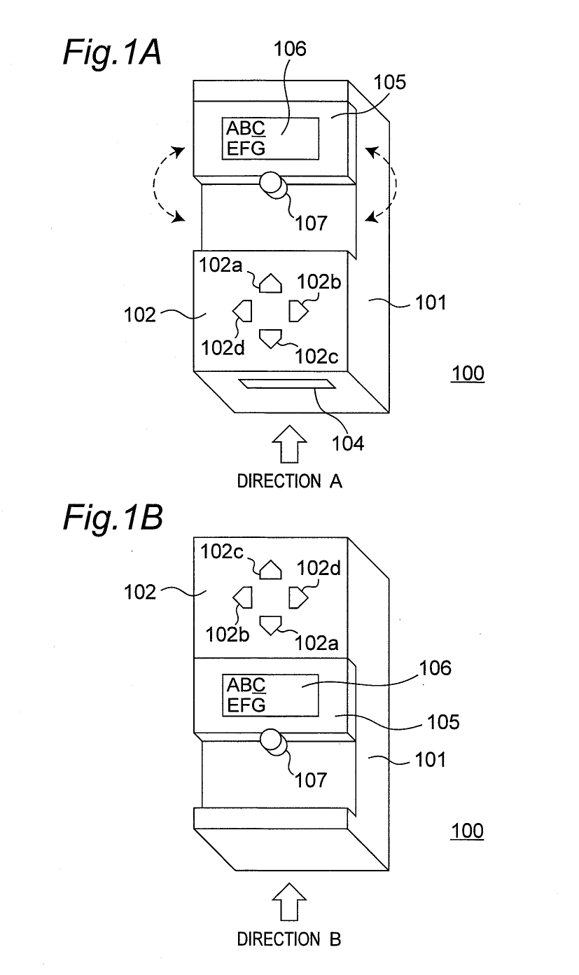

FIG. 1A shows an outline view of a video display terminal in Embodiment 1 of the invention. As shown in FIG. 1A, a video display terminal 100 has a first case 101 functioning as a main body, and a second case 105 attached turnably on the first case 101. The first case 101 has an operation section 102 including cursor keys 102a, 102b, 102c, and 102d, and a slot 104 to which a removable recording medium such as an SD card (registered trademark) is loaded. Hereinafter, the surface of the case 101 on which the operation section 102 provided is called an “operation surface.”

The second case 105 has a display 106 for displaying video, text, characters and others. The display 106 is composed of, for example, a liquid crystal display device (LCD). The second case 105 is attached to the first case 101 by way of a hinge section 107 to be turnable around the axis of turning vertical to the operation surface. The display 106 shows a content while setting the direction of displaying the content so that the hinge section 107 is located below the displayed content.

In the following explanation, for the video display terminal 100, the end portion having the slot 104 is referred to as the “original lower part of the video display terminal 100,” and the end portion not having the slot 104 is referred to as the “original upper part of the video display terminal 100.” The angle of turning of the display 106 shown in FIG. 1A is 0 degree, and the position of this display 106 is called the “first position.”

FIG. 1B is a view of the video display terminal 100 in a state where the display 106 of the video display terminal 100 is turned by 180 degrees from the first position and the main body of the video display terminal 100 is turned upside down. The angle of turning of the display 106 shown in FIG. 1B is 180 degrees, and the position of this display 106 is called a “second position.”

The video display terminal 100 can be easily manipulated in various directions by the operator. For example, functions of the operation keys are assigned so that the operation keys may be handled intuitively by the operator, when manipulating the operation keys with the original upper part of the video display terminal 100 set to the upper side as seen from the operator, as shown in FIG. 1A, or when manipulating the operation keys with the original upper part of the video display terminal 100 set to the lower side as seen from the operator, as shown in FIG. 1B. The detail of function assignment of operation keys is described later.

### 2. Configuration of Video Display Terminal

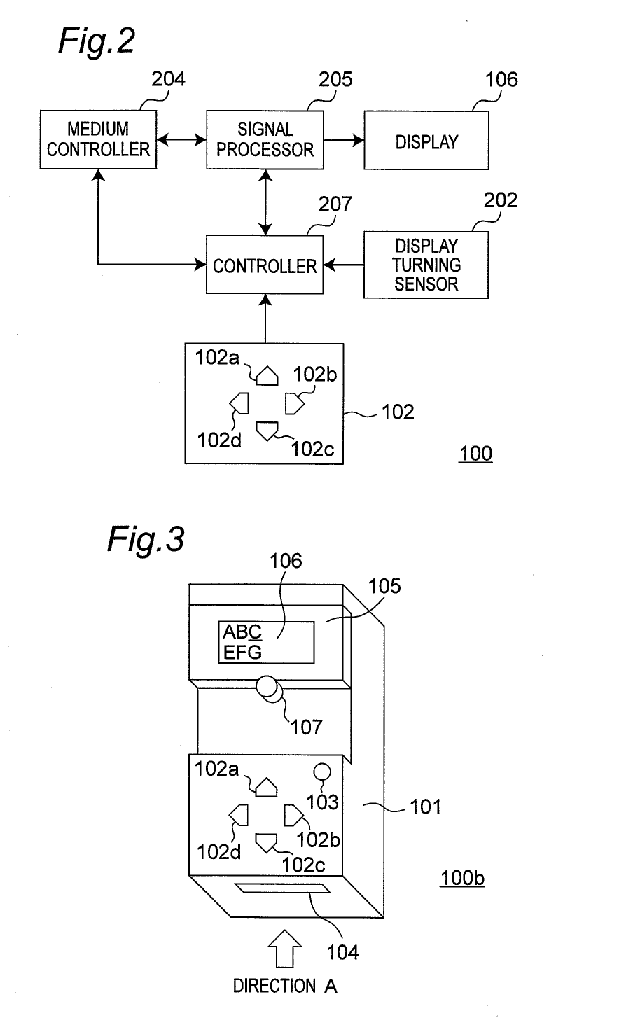

FIG. 2 is a block diagram of configuration of the video display terminal 100 in Embodiment 1 of the invention. The video display terminal 100 includes a medium controller 204 for controlling access to a removable recording medium, a signal processor 205 for processing a video signal and outputting it to the display 106, and a controller 207 for controlling the entire operation of the video display terminal 100. The operation section 102 and a display turning sensor 202 are connected to the controller 207.

The operation section 102 includes cursor keys 102a, 102b, 102c, and 102d for moving a cursor shown on the display 106 in any one of up, down, right and left directions and for transmitting information of the key manipulated by the operator to the controller 207. The display turning sensor 202 detects a turning angle of the second case to the first case. For example, The display turning sensor 202 detects 0 degree when the display 106 is at the first position, or 180 degrees when the display 106 is at the second position to output a detection signal.

The media controller 204 controls detection of insertion or removal of the removable recording medium in the slot 104 or reading of data from the removable recording medium. The signal processor 205 converts the video data received from the media controller 204 to a video signal, and outputs it to the display 106. The display 106 displays the video signal from the signal processor 205.

The controller 207 commands display setting of video in the signal processor 205 and reading of data into the medium controller 204. In particular, the controller 207 changes the assignment of function of keys of the operation section 102 on the basis of the turning angle information from the display turning sensor 202. The key function assignment is realized by the software.

### 3. Function Assignment to Operation Keys

The following is the explanation about the function assignment to the operation keys on the video display terminal in each state of FIGS. 1A and 1B. In FIG. 1, it is supposed that the video display terminal is installed in a horizontal place, specifically in FIG. 1A, the video display terminal 100 is operated by the operator from the direction indicated by the arrow A, and in FIG. 1B, the video display terminal 100 is operated by the operator from the direction indicated by the arrow B. That is, in the case of FIG. 1A, the operator operates the video display terminal 100 from its original direction, and in the case of FIG. 1B, the operator operates the video display terminal 100 from the opposite direction of its original direction.

First, the function assignment to operation keys on the video display terminal in the state shown in FIG. 1A is explained.

In FIG. 1A, the display 106 is at the first position. The controller 207 receives information of turning angle (0 degree) from the display turning sensor 202, and recognizes that the display 106 is at the first position on the basis of this information. That is, on the basis of the information of turning angle (0 degree), the controller 207 judges that the operator operates the video display terminal 100 from its original direction.

Considering that the operator operates from the side of the arrow A, it is judged that, when seen from the operator, the key 102a is positioned at upper side from the other keys, the key 102b at the right side, the key 102c at the lower side, and the key 102d at the left side. Therefore, when the key 102a is pressed down, the cursor on the display 106 should move upward, when the key 102b is pressed down, the cursor should move to the right, when the key 102c is pressed down, the cursor should move downward, and when the key 102d is pressed down, the cursor should move to the left. Therefore the controller 207 assigns the cursor keys 102a to 102d of the operation section 102 with functions as follows.

The key 102a is assigned with an up-key function (a function of moving the cursor on the display 106 upward when the key is pressed down). The key 102b is assigned with a right-key function (a function of moving the cursor to the right when the key is pressed down). The key 102c is assigned with a down-key function (a function of moving the cursor downward when the key is pressed down). The key 102d is assigned with a left-key function (a function of moving the cursor to the left when the key is pressed down). The function assignment of the operation key when the display position is at the first position is called a “standard assignment.”

By assigning the keys in this manner, when the operator operates the video display terminal 100 from the direction of arrow A, when the key 102a positioned upper part of the operation section 102 is pressed down, the cursor moves upward, and when the key 102c positioned lower part is pressed down, the cursor moves downward. This is also applied to the right and left directions. Accordingly, the display directions on the display 106 coincide with the functions of the operation keys 102a to 102d, so that the operator can operate intuitively.

Next, the function assignment to operation keys in the video display terminal 100 in the state as shown in FIG. 1B is explained.

In FIG. 1B, the display 106 is at the second position. The controller 207 receives information of turning angle (180 degrees) from the display turning sensor 202, and recognizes that the display 106 is at the second position on the basis of this information. That is, on the basis of the information of turning angle (180 degrees), the controller 207 can judge that the operator is manipulating the video display terminal 100 while holding it upside down to the original direction.

Here, considering that the operator manipulates from the arrow B side, it is judged that, when seen from the operator, the key 102c is positioned at upper side from the other keys, that the key 102d is positioned at the right, that the key 102a is positioned at lower side, and that the key 102b is positioned at the left. Therefore, when the key 102c is pressed down, the cursor on the display 106 should move upward, when the key 102d is pressed down, the cursor is supposed to move to the right, when the key 102a is pressed down, the cursor is supposed to move downward, and when the key 102b is pressed down, the cursor should move to the left. Accordingly, the controller 207 assigns the cursor keys of the operation section 102 with functions inverted in up and down, and right and left directions, from the standard assignment. Such function assignment is called a “inverted assignment.” Specifically, the assignment is done as follows.

The key 102a is assigned with the down-key function. The key 102b is assigned with the left-key function. The key 102c is assigned with the up-key function. The key 102d is assigned with the right-key function.

By thus assigning the keys with individual functions, even if the main body of the video display terminal 100 is used upside down, the display direction on the display 106 and the functions of the operation keys 102a to 102d are matched so that intuitive manipulation by the operator can be achieved.

### 4. Summary

As described herein, the video display terminal 100 of the present embodiment detects the direction of the display 106 by the display turning sensor 202, and changes the function assignment of the cursor keys according to the detection result so as to coincide with the display direction on the display 106. As a result, along with changes in the direction of the display 106, even if the display direction on the display 106 is changed, the display direction on the display 106 coincides with the functions of the operation keys so that operation errors of cursor keys can be prevented and convenience of key manipulation is boosted for the operator.

### Embodiment 2

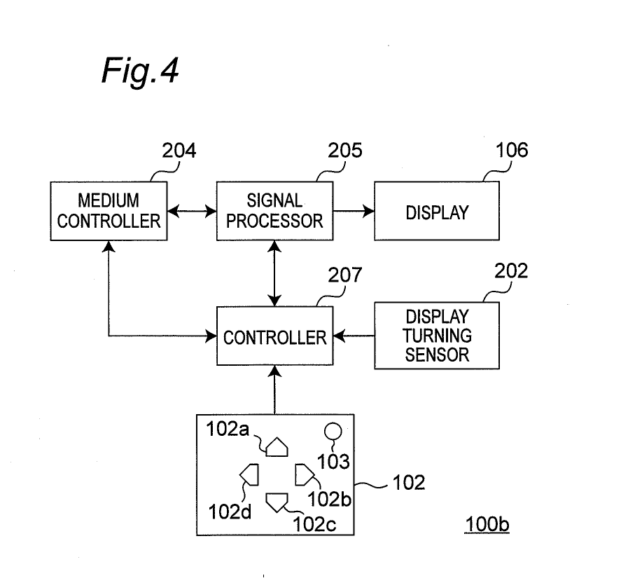

FIG. 3 shows an outline view of a video display terminal according to Embodiment 2 of the invention. FIG. 4 shows a configuration of the video display terminal in Embodiment 2. The video display terminal 100b of this embodiment is further provided with a display invert key 103 in the operation section 102. The display invert key 103 is to turn forcedly the display direction on the display 106 upside down. That is, every time the display invert key 103 is pressed, the display direction on the display 106 is inverted by 180 degrees.

The video display terminal 100b of the present embodiment operates in the same manner as in the video display terminal 100 of Embodiment 1. That is, also in the video display terminal 100b, similarly to Embodiment 1, the controller 207 changes over the display on the display 106 on the basis of the information from the display turning sensor 202, and assigns the functions of the operation section 102. In the following explanation, in particular, the operation relating to the display invert key 103 in the video display terminal 100b is described.

Referring to FIG. 4, when receiving a signal from the operation section 102 and detecting that the display invert key 103 is pressed, the controller 207 transmits a control signal for displaying an image turned by 180 degrees (up-down inverted and right-left inverted) to the signal processor 205. The signal processor 205 receives this control signal and transmits a video signal for displaying the image turned by 180 degrees to the display 106. By this operation, the image on the display 106 is turned by 180 degrees. At the same time, the controller 207 changes the assignment of the functions of the cursor keys 102a to 102d of the operation section 102. More specifically, the function assignment is changed over between the keys 102a and 102c located on the upper and lower side, and the function assignment is changed over between the keys 102b and 102d located on the left and right side. As a result, even if the display direction on the display 106 is inverted with the display invert key 103, the key assignment coinciding with the display direction is realized.

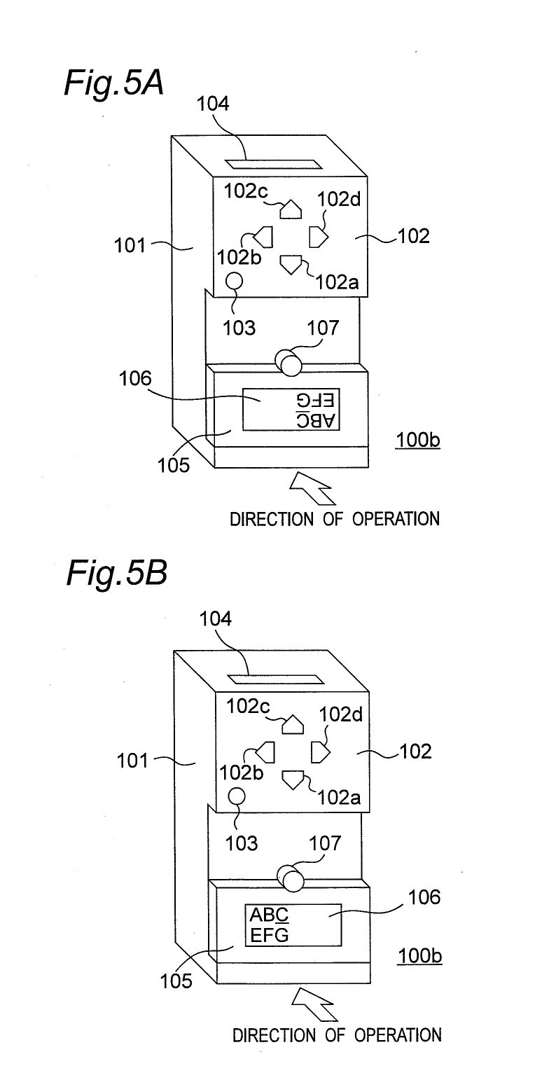

For example, when the video display terminal 100b in the state as shown in FIG. 3 is turned upside down, the state becomes as shown in FIG. 5A. In this case, the position of the display 106 remains at the first position, and the display direction is not changed. Hence, when seen from the operator, the content displayed on the display 106 may be displayed upside down, and thus it is hard to recognize for the operator. In such circumstance, the display invert key 103 is effective.

When the display invert key 103 is pressed in the state in FIG. 5A, the display on the display 106 is turned by 180 degrees (inverted up-down, and inverted right-left) as shown in FIG. 5B. At the same time, the function assignment of the cursor keys 102a to 102d is changed according to the display direction on the display 106. That is, the assignment is inverted. More specifically, the key 102a is assigned with a down-key function, the key 102b is assigned with a left-key function, the key 102c is assigned with an up-key function, and the key 102d is assigned with a right-key function.

In the state shown in FIG. 5B, when the display invert key 103 is pressed again, the display on the display 106 is inverted up, down, right, and left, and the function assignment of the cursor keys 102a to 102d is inverted up, down, right, and left (standard assignment), thereby returning to the state as shown in FIG. 5A.

In this manner, with the display invert key 103, regardless of the display direction on the display 106, the display direction and the function assignment of the cursor keys 102a to 102d are changed by force, so that a convenient key assignment for the operator is realized, that erroneous operation of keys can be prevented, and that the convenient manipulation and visual recognition are boosted. For example, when the video display terminal 100b is located in a horizontal place, and plural operators facing each other manipulate the video display terminal 100b at both side of the video display terminal 100b, the function assignment of the cursor keys 102a to 102d and the display direction can be changed over instantly by using the display invert key 103, so that the convenience of the operation section 102 can be substantially boosted.

In Embodiments 1 and 2, the cursor key is a key of which function assignment is changed depending on the direction of the display 106, but the invention is not limited to this example. For example, numeric keys 0 to 9 may be also changed in the function assignment depending on the direction of the display 106 if disposed nearly symmetrically in the up, down, right and left directions.

Further, the functions to be assigned to the operation keys are not limited to functions of moving the cursor in up, down, right, and left directions or numeric keys. For example, regarding keys relating to playback function, in the standard assignment, the key 102a may be assigned with “pause” function, the key 102b may be assigned with “skip (fast forward)” function, the key 102c may be assigned with “stop” function, and the key 102d may be assigned with “skip (rewind)” function, and in the inverted assignment, the up and down keys, and the right and left keys may be assigned inversely from the standard assignment. In this manner, depending on the direction of the display 106, arbitrary functions may be changed over between standard assignment and inverted assignment, so that the convenience of the operation section 102 may be boosted.

Instead of providing the cursor keys 102a to 102d separately, they may be integrated into one key such as a cross-key. Alternatively, instead of the operation keys, stick type input means for outputting a signal depending on the tilted direction may be also used. In this case, the function assignment of the input means may be changed depending on the display position.

In the above example, every time the display 106 is turned by 180 degrees, the key assignment in the operation section 102 is changed over, but the key assignment may be changed in every 90 degrees. In this case, it is preferred to dispose the operation keys in the operation section 102 so that the layout of the operation keys does not change even if the display 106 is turned by 90 degrees.

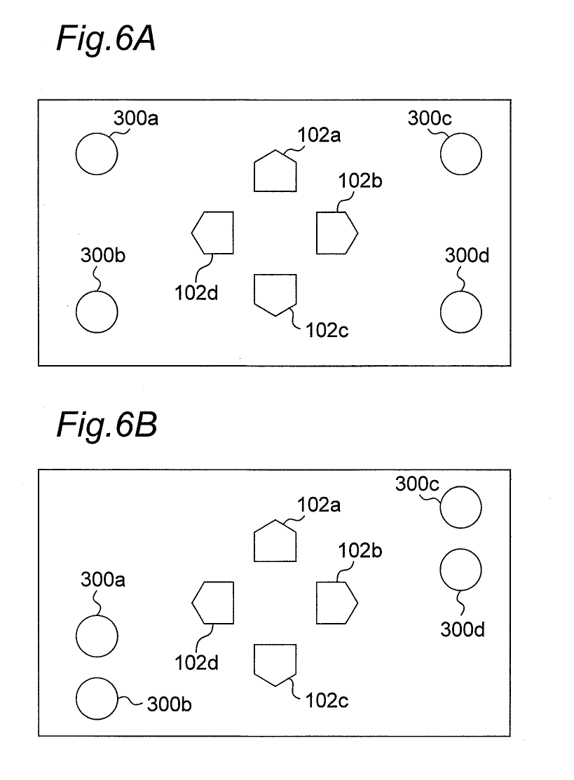

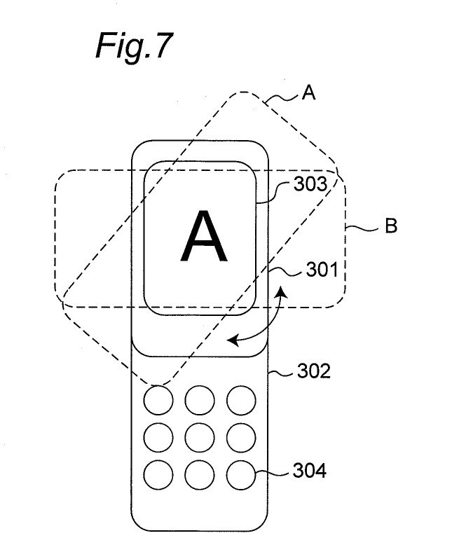

The keys in the operation section 102 are preferred to be disposed point-symmetrically about the center of the operation section 102. FIGS. 6A and 6B show a point symmetrical arrangement of operation keys. The point symmetrical arrangement of operation keys can achieve an ideal key arrangement for allowing the operator to perform intuitive manipulation when the function assignment is changed over between the standard assignment and the inverted assignment. For example, in the example shown in FIGS. 6A and 6B, when the display is inverted depending on the position of the display 106, the functions are changed over between the key 300a and the key 300d and between the key 300b and the key 300c. The cursor keys 102a to 102d are changed over in function as mentioned above. The symmetrical arrangement of operation keys can achieve an ideal key arrangement regardless of the position of the display 106, so that the operator can manipulate intuitively while observing the display on the display 106.

In the above example, although it is explained that the second case 105 including the display 106 is turned two-dimensionally about the axis of the hinge section 107, the hinge section 107 may be also movable three-dimensionally. In this case, too, the functions of the operation keys of the operation section 102 may be assigned so as to match the direction of the display 6 with the direction of the operator.

### INDUSTRIAL APPLICABILITY

As described above, the terminal having display section of the invention is always matched in the relation between the display direction and the operation keys, and erroneous operation of keys can be prevented. Thus it is very useful for a portable terminal having a movable display and operation keys of which physical positions are not changeable (portable telephone terminal, video playback device, and so on.)

1. A terminal comprising:
a first case provided with operation section including a plurality of operation keys;
a second case including a display section and provided turnably on the first case;
an angle detector for detecting a turning angle of the second case with respect to the first case; and
a controller for changing assignment of function of the operation key of the operation section depending on the turning angle detected by the angle detector.

2. The terminal according to claim 1, wherein the plurality of operation keys include a plurality of cursor keys capable of moving a cursor displayed on the display in up, down, right and left directions, and the controller changes the functions assigned to the cursor keys depending on the detected turning angle.

3. The terminal according to claim 2, wherein the plurality of operation keys include a display invert key, and when the display invert key is pressed down, the controller inverts the function assigned to the cursor key between up and down directions and right and left directions, and inverts content displayed on the display section between up and down directions and between right and left directions.

4. The terminal according to claim 1, wherein
the controller assigns the operation keys of the operation section with functions according to a first method, when the turning angle detected by the angle turning detector is a first angle by which it is judged that the operator is manipulating the terminal from a front direction, and
the controller assigns the operation keys of the operation section with functions by inverting the function assignment in the up-down direction and the right-left direction of the function assigned in the first method, when the turning angle detected by the angle turning detector is a second angle by which it is judged that the operator is manipulating the video display terminal from an opposite direction to the front direction.

5. The terminal according to claim 1, wherein the operation keys of the operation section are disposed point symmetrically about the center of the operation section.
